(19) United States
(12) Patent Application Publication
(10) Pub. No.: US 2026/0147361 A1
(43) Pub. Date: May 28, 2026

(54) MULTI-LAYERED PLANNERS FOR CLOSE ADHERENCE TO EDGES BY A ROBOT SWEEPER

(71) Applicant: ViaBot, Inc., Santa Clara, CA (US)

(72) Inventors: John Lee, Sunnyvale, CA (US); Raj Shinde, Santa Clara, CA (US); Yashaarth Todi, Santa Clara, CA (US)

(21) Appl. No.: 19/401,212

(22) Filed: Nov. 25, 2025

Related U.S. Application Data
(60) Provisional application No. 63/725,519, filed on Nov. 26, 2024.

(51) Int. Cl. G05D 1/648; B25J 11/00

(52) U.S. Cl. CPC G05D 1/6484; B25J 11/0085

(57) ABSTRACT

A method for controlling autonomous movement by a robot module is provided, including: generating a plurality of waypoints by a global planner; generating a plurality of velocities by a local planner, said velocities being configured to navigate the robot module through said waypoints; applying the velocities to control movement of the robot module.

### CLAIM OF PRIORITY

This application claims priority to U.S. Provisional Application No. 63/725,519, filed on November 26, 2024, entitled “MULTI-LAYERED PLANNERS FOR CLOSE ADHERENCE TO EDGES BY A ROBOT SWEEPER”, which is herein incorporated by reference.

### RELATED APPLICATIONS

This application is related to U.S. Patent Application No. 17/134,102 filed on Dec. 24, 2020 and entitled “SYSTEMS FOR SETTING AND PROGRAMMING ZONING FOR USE BY AUTONOMOUS MODULAR ROBOTS,” and to U.S. Provisional Patent Application No. 63/725,522 (Attorney Docket No. VBOTP007+), filed on November 26, 2024 entitled “MULTI-PURPOSE MISSION PLANNER FOR ROBOT SWEEPER,” and to U.S. Provisional Patent Application No. 63/725,524 (Attorney Docket No. VBOTP008+), filed on November 26, 2024, and entitled “2D MAP MANAGEMENT BY A ROBOT SWEEPER,” the disclosures of which are herein incorporated by reference.

### FIELD

The present disclosure relates generally to systems and methods for implementing multi-layered planners for close adherence to edges by a robot sweeper.

### BACKGROUND

Autonomous robots are becoming increasingly prevalent due to their ability to automatically perform a variety of tasks that are typically performed manually by humans, or that have been performed with direct human control of a machine. An example of an autonomous robot is a robotic sweeper which can be used to clean surfaces such as the parking surface of a parking lot. Such robots are often programmable, allowing users to configure operation times, frequency of operation, and various other settings for the robots. Once programmed, the robots may perform a task, move, and interact with the surrounding environment without requiring further human input. However, challenges remain in providing optimal autonomous navigation of a robot.

It is in this context that embodiments of the disclosure arise.

### SUMMARY

Methods, systems, and computer systems are provided for multi-layered planners for close adherence to edges by a robot sweeper.

In the presently disclosed implementations, a multi-layered planning approach enables close adherence to curbs and close following around obstacles by a robot sweeper. The multiple planning layers include a global planner and a local planner that may operate at different update frequencies. For example, the global planner can provide dynamically generated cm-scale waypoints at about 1 Hertz (Hz), while the local planner dynamically generates velocities at about 10 Hertz to navigate the robot along the waypoints. Both the global and local planner are updated based on sensor data (e.g. camera, lidar, ultrasonic, etc.) to enable planning and navigating around obstacles such as cars.

In some implementations, a method for controlling autonomous movement by a robot module is provided, including: generating a plurality of waypoints by a global planner; generating a plurality of velocities by a local planner, said velocities being configured to navigate the robot module through said waypoints; applying the velocities to control movement of the robot module.

In some implementations, the waypoints are continually generated at a first frequency, and wherein the velocities are continually generated at a second frequency greater than the first frequency.

In some implementations, the first frequency is in the range of about 1 to 5 Hertz, and wherein the second frequency is in the range of about 10 to 20 Hertz.

In some implementations, the waypoints are configured to be about 0.5 to 2 centimeters apart.

In some implementations, the waypoints are configured so that the movement of the robot module continually positions the robot module in proximity to a curb or wall.

In some implementations, the positioning of the robot module is further configured to position a sweeper brush of the robot module in contact with, or in proximity to, the curb or wall.

In some implementations, the robot module is configured to sense a local environment using one or more sensors; and, wherein generating the waypoints or generating the velocities is responsive to the sensing of the local environment.

In some implementations, sensing the local environment includes recognizing objects in the local environment by applying a recognition model to sensor data generated by the one or more sensors.

In some implementations, responsive to detection of an obstacle in the local environment, then the waypoints or velocities are generated so as to avoid contact of the robot module with the obstacle.

In some implementations, applying the velocities includes activating or controlling one or more actuators of the robot module to control the movement of the robot module according to the velocities.

In some implementations, a method for controlling autonomous movement by a robot module is provided, including: sensing a local environment in which the robot module is disposed using one or more sensors of the robot module, wherein sensing the local environment is configured to detect a curb or wall in the local environment; generating a plurality of waypoints by a global planner, wherein responsive to the detection of the curb or wall, the waypoints are configured to position the robot module at a first predefined distance from the curb or wall; generating a plurality of velocities by a local planner, said velocities being configured to navigate the robot module through said waypoints; applying said velocities to control movement of the robot module.

In some implementations, sensing the local environment is configured to detect an obstacle in the local environment, and wherein responsive to the detection of the obstacle, then the waypoints are configured to position the robot module at a second predefined distance from the obstacle that is greater than the first predefined distance.

In some implementations, the first predefined distance is configured to position a sweeper brush of the robot module in contact with the curb or wall, and wherein the second predefined distance is configured to position the sweeper brush to avoid contact with the obstacle.

In some implementations, the waypoints are continually generated at a first frequency, and wherein the velocities are continually generated at a second frequency greater than the first frequency.

In some implementations, sensing the local environment includes recognizing objects in the local environment by applying a recognition model to sensor data generated by the one or more sensors.

In some implementations, a robot module configured for autonomous movement is provided, including: a global planner that generates a plurality of waypoints; a local planner that generates a plurality of velocities, said velocities being configured to navigate the robot module through said waypoints; one or more actuators that implement the velocities to control movement of the robot module.

The foregoing is a summary of certain embodiments in accordance with implementations of the disclosure. It will be appreciated that other embodiments and implementations will be realized upon a full understanding of the present disclosure.

### BRIEF DESCRIPTION OF THE DRAWINGS

FIG. 1 illustrates a high level diagram of a robot module that is designed for a sweeping work function, in accordance with one embodiment.

FIG. 2 illustrates a perspective view of robot module configured to follow a path adjacent to a curb, in accordance with implementations of the disclosure.

FIG. 3 conceptually illustrates an overhead view of a robot module that generates waypoints that enable close adherence to a curb, in accordance with implementations of the disclosure.

FIG. 4 conceptually illustrates a robot module traversing various waypoints by applying generated velocities, in accordance with implementations of the disclosure.

FIG. 5 conceptually illustrates an overhead view of robot module avoiding obstacle, in accordance with implementations of the disclosure.

FIG. 6 conceptually illustrates componentry of a robot module, in accordance with implementations of the disclosure.

The drawings are provided to illustrate examples of embodiments and are not intended to limit the scope of the disclosure. In addition, features in the drawings are not necessarily to scale.

### DETAILED DESCRIPTION

Methods and systems for controlling operation by autonomous modular robots are disclosed. The methods include hardware and/or software systems that are used to interface with and control operation of an autonomous modular robot that is programmed to perform a task. Broadly speaking, the autonomous modular robot may be referred to by a number of names, such as, the robot (module), the modular robot, the (robot) sweeper, the scrubber, the autonomous vehicle, the vehicle, the cutter, the mower, the autonomous unit, and other similar names. The modular robot can therefore be configured to perform different tasks, or work functions. These tasks can include, without limitation, ground cleaning, floor source cleaning, ground scrubbing, ground vacuuming, sweeping of paved surfaces (e.g. parking lots, buildings, roads, etc.), or other types of outdoor or indoor surfaces or spaces. In one example, the modular robot may be configured for sweeping. Such a configuration may include a robot, a sweeper module, and a dock assembly.

The robot is mobile (e.g., has wheels or tracks), and is configured to engage and retain the sweeper module, and maneuver the sweeper module over a given surface to be cleaned. The sweeper module is a modular unit having brushes that sweep debris from the surface into an included collection container. If the work function is to scrub a surface, a scrubber module may be picked up by the robot instead of a sweeper module. The same applies to a mower module, which can be picked up from a respective docking station to enable mowing of a lawn, shrubs, or grass.

In the case of a robot that performs removal of trash or other debris from a surface (e.g. parking lot), close adherence to curbs and along walls or other structures at the edge of a surface is desirable, as debris tends to accumulate in such edge regions. It can be desirable to have sweeper brushes of the robot physically contact the curb in order to provide effective cleaning at the edge. However, if the robot encounters an obstacle such a parked car, it is desirable for the robot to avoid physical contact with the parked car, while also following a path that nonetheless closely hews to the external footprint of the parked car. In this manner, the robot sweeper can maximize cleaning along edges while also avoiding contact with obstacles.

These and other features described herein will now be further described with reference to the following drawings.

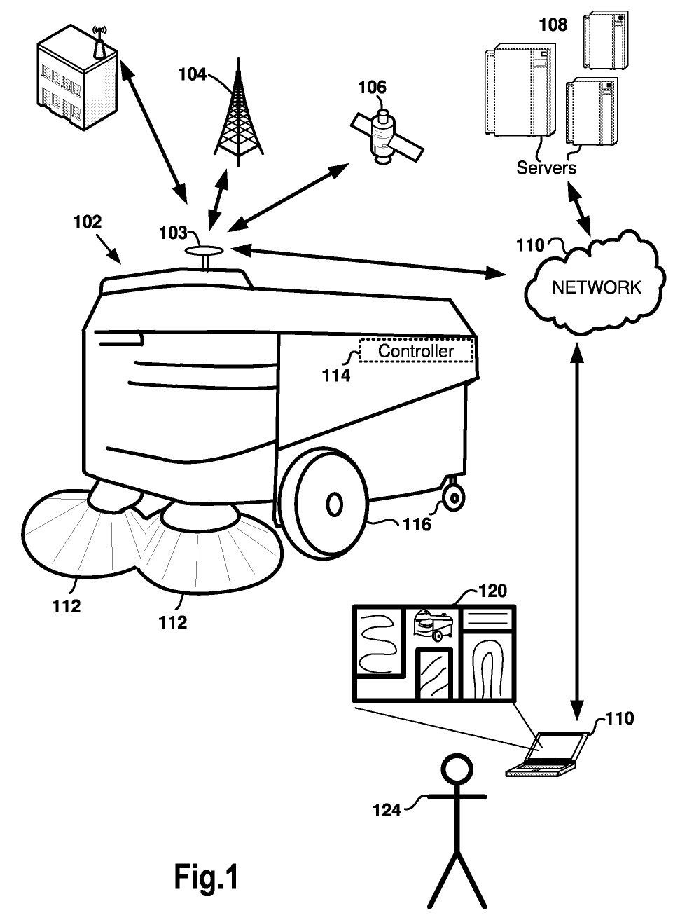

FIG. 1 illustrates a high level diagram of a robot module 102 that is designed for a sweeping work function, in accordance with one embodiment. As shown, the robot module 102 includes brushes 112, which are utilized to sweep debris collected from surfaces, such as parking lots, hard surfaces, buildings, and the like. In one embodiment, the robot module 102 includes a sweeping module (not shown) which is contained within the robot module 102, and the sweeping module is connected to the brushes 112. For more information on the modular interface between the robot module 102 and the sweeping module, reference may be made to U.S. Provisional Patent Application No. 63/087,179, filed on October 3, 2020, which is herein incorporated by reference. The robot module 102 includes one or more antenna 103, which is used by the robot module 102 to communicate wirelessly with one or more different types of communication devices. In one embodiment, the antenna 103 can include the communications device for communicating with the network 110.

The communications device can be an Ethernet controller that allows for Wi-Fi or cellular connection to the network 110. In some embodiments, high-speed cellular can be utilized for the communication, such as 5G communication. In some embodiments, the antenna 103 can be configured to communicate with a cell tower 104, or multiple cell towers 104 for enabling the communication with the network 110. In some embodiments, the GPS transponder can be provided in the robot module 102, to enable communication with a global positioning system (GPS) device 106. The robot module 102 may also communicate with local GPS 106a, for higher precision economist movement. Broadly speaking, GPS coordinates obtained from a GPS 106 may not provide sufficient precision and movement when the robot module 102 is required to perform fine tune movements, based on the work function.

The local GPS 106a, for example, may be installed at the location where the robot module 102 is to perform its work function. As mentioned above, mapping data can be generated for a location to enable the robot module 102 to move efficiently about the location in which the work function is to be performed. Network 110 is shown communicating with servers of a data center 108. The servers 108 may be replicated among one or more data centers depending on the location of the robot module 102 and the desired communication with those robots. For example, robot modules 102 operating in California may utilize local region data centers 108, and robot modules 102 operating in New York may utilize local region data centers 108 to reduce delay. As will be described in greater detail below, the servers of the data center may be utilized to communicate instructions to the robot modules 102. The instructions provided to the robot module 102 can include information for defining zones at specific locations, where the robot module 102 is to perform its work function.

The instructions can be custom tailored by the manager of the location where the robot module 102 is to perform its work function. In some embodiments, the manager is the user 124, which has access to a computer 110 for visualizing the location where the work function is to be performed. The user interface 120 may be provided which highlights the layout of the location, and allows for the user 124 to customize the zones to be used to perform the work functions. The robot module 102 is shown to include wheels 116 to enable the robot module 102 to function in its autonomous movement. The autonomous movement of the robot module 102 can be customized based on a schedule, and can be customized to allow the user 124 to define different work functions to be performed in different zones of a location being managed. The controller 114 of the robot module 102 includes electronics that provide for autonomous movement of the robot module 102, and interfacing with electronics of the sweeper module being used by the robot module 102.

The robot module 102 includes batteries to enable electric vehicle movement and operation, and the sweeper module included in the robot module 102 will also include batteries for providing power to perform the work function. In one embodiment, the robot module 102 is configured to be docked at a docking station, where the robot module and its batteries can be charged.

The robot module 102 uses one or more of a number of guiding technologies for autonomous movement, such as GPS, local GPS, cameras for vision assisted movement, LIDAR, radar, sonar, ultrasonic proximity sensors, depth cameras, or combinations of two or more thereof.

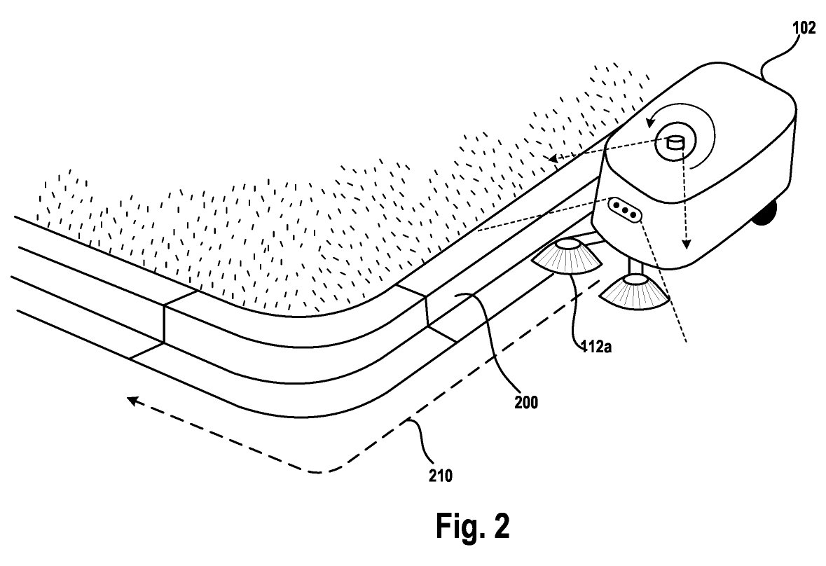

FIG. 2 illustrates a perspective view of robot module configured to follow a path adjacent to a curb, in accordance with implementations of the disclosure.

In the illustrated view, a robot module 102 is configured as an autonomous sweeper used to perform sweeping of a surface in order to remove debris and clean the surface. As shown, the robot module 102 is performing sweeping along a curb 200, and as such, it is desirable for the robot module 102 to closely adhere to the curb 200, so that the edges of the brush 112a may contact the curb 200, or be positioned substantially at the curb 200, such as being positioned within about 0 to 5 cm of the curb 200. In this manner, the robot module 102 can effectively remove debris that may have accumulated along the curb 200.

In order to enable the robot module 102 to closely adhere to the curb 200, the robot module 102 follows a path 210 that is configured to position the robot module at a distance from the curb 200 providing for placement of the brush 112a in contact with, or substantially at or near, the curb 200. As described in further detail below, the path followed by the robot module 102 can result from implementation of a global planner and a local planner. Broadly speaking, the global planner continually generates a sequence of waypoints which collectively define an intended path for the robot module 102 to follow. And the local planner continually generates velocities for the robot module 102 to execute on in order to navigate the robot module 102 to the next waypoint. For example, the velocities may be implemented by a controller of the robot module that controls the operation of motors or steering servos, etc., so as to effect and control the movement of the robot module in its environment according to the velocities. Both the waypoints and velocities generated by the global and local planners are further subject to feedback from the robot module’s sensors, so that they may be changed in response to real-time or changing conditions.

In some implementations, the global planner continually generates waypoints at approximately centimeter scale, e.g. about 0.5 to 2 cm apart in some embodiments, or about 1 cm apart in some embodiments, etc. In some implementations, the global planner continually generates waypoints at approximately 1 Hertz, that is, about once per second. In some implementations, the local planner continually generates velocities at approximately 10 Hertz, that is, about 10 times per second.

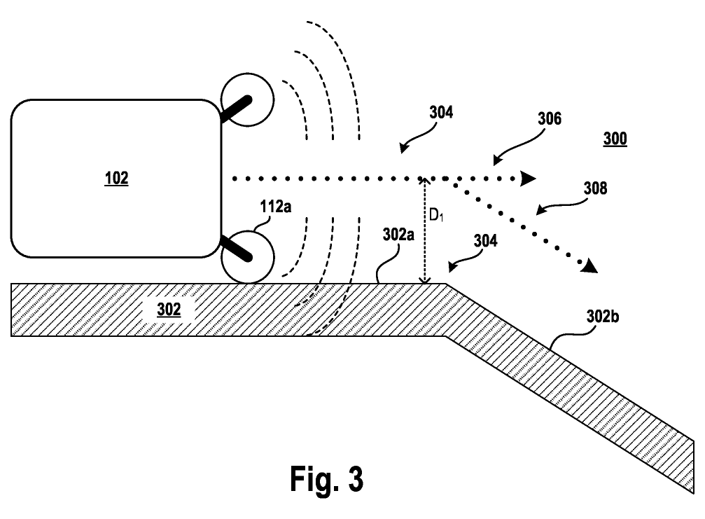

FIG. 3 conceptually illustrates an overhead view of a robot module that generates waypoints that enable close adherence to a curb, in accordance with implementations of the disclosure.

In the illustrated implementation, the robot module 102 is configured as a robot sweeper, engaged in cleaning of a surface 300, which can be a surface of a parking lot or road by way of example without limitation. More specifically, the robot module 102 is engaged in cleaning along a curb 302, and thus it is desirable for the robot module 102 to follow a path that positions a brush 112a of the robot module in contact with, or proximate to, the sidewall 302a of the curb 302.

In some implementations, the robot module 102 employs a global planner that generates waypoints (conceptually shown at ref. 304) which collectively define an intended path for the robot module 102 to follow. Broadly speaking, each waypoint defines a target location for the robot module 102 to navigate to. In some implementations, the waypoints are two-dimensional coordinates, whereas in other implementations, the waypoints can be three-dimensional coordinates. In some implementations, the waypoints are spaced apart at approximately centimeter scale, such as being spaced apart by a distance in the range of about 0 to 5 cm in some implementations, or about 0 to 2 cm in some implementations. In some implementations, the waypoints are spaced apart by a distance greater than about 5 cm.

Furthermore, in some implementations, the distance between waypoints (or the density of waypoints) can vary depending upon the contour of the curb 302 that the robot module 102 is attempting to follow. For example, the distance between waypoints can be configured to decrease (waypoint density increases) as the amount of curvature or deviation from a straight contour increases (e.g. angles, turns, corners, etc.). Thus if the contour of the curb 302 is substantially straight then the waypoints can be spaced apart at a greater distance (density of waypoints decreased), whereas if the contour of the curb is curved or otherwise changing from a straight contour, then the waypoints can be spaced apart at a shorter distance (density of waypoints increased). In this manner, fewer waypoints are required when the robot is following a principally straight path (e.g. along a straight curb) as the robot module does not need to make significant changes in its trajectory in order to follow such a straight path. Whereas more waypoints are utilized to follow a curved/non-straight path of a similar distance (e.g. along a curved curb), thereby enabling the robot module to more closely adhere to the contour of the curb.

In order to generate waypoints enabling the robot module 102 to closely follow the contour of the curb 302, the global planner dynamically generates the waypoints in a continual manner, so that waypoints covering a given range are generated and updated based on real-time sensor data gathered by the robot module 102. In some implementations, waypoints are generated at a frequency of about 1 Hertz, so that a set of waypoints covering a given range or path length are generated about once per second. In various implementations, waypoints can be generated at a frequency greater than about 0.5 Hertz, in the range of about 0.5 to 10 Hertz, etc. In some implementations, the frequency at which waypoints are generated may vary based on factors such as the current speed or velocity of the robot module, the linearity or non-linearity of the currently generated waypoints, the proximity of the robot module to another object, the sensed motion of another object, etc.

It will be appreciated that with each cycle of waypoint generation, the generated waypoints will cover a given range and define an intended path for the robot module 102. In some implementations, the range of waypoints generated in one cycle is defined by a predefined number of waypoints. In some implementations, the range of waypoints generated is configured to cover a predefined distance or a predefined path length from the current location of the robot module 102. In some implementations, the range of waypoints generated may vary based on factors such as the linearity or non-linearity of the waypoints, the frequency at which waypoints are being generated, etc.

In some implementations, the waypoints are generated anew with each cycle, so that an entirely new set of waypoints is generated each time based on the robot module’s current and/or predicted location. In some implementations, the waypoints are generated in a manner that is additive upon previously generated waypoints, so that successive waypoints are added to the end of the previously generated waypoints. In such implementations, existing waypoints may be verified and possibly changed/updated based on sensor data if necessary.

In order to facilitate close following of the curb 302, in some implementations, the waypoints 304 are generated to be at a predefined distance D₁ from the sidewall 302a of the curb 302, so as to place the brush 112a in contact or close proximity with the sidewall of the curb. In some implementations, the curb 302 is continually recognized in real-time based on sensor data from sensors included in the robot module 102 (e.g. one or more cameras, LIDAR sensors, ultrasonic sensors, GPS, etc.). In some implementations, one or more machine learning models is used to process such sensor data in order to recognize the curb 302. As the curb 302 is recognized, then the location of the robot module 302 relative to the curb’s sidewall can be determined, and the waypoints can be generated and/or updated so as to maintain the desired distance from the sidewall of the curb.

In some implementations, the sensors can include one or more pressure/force sensors that detect deflection forces against the brushes of the robot module, such as may be caused when a brush is pressed into the curb. In some implementations, such sensor data is used to determine the location of the robot module relative to the curb, and to generate/update waypoints.

It will be appreciated that as the specific contours of the curb 302 are detected in real-time, then the waypoints generated by the global planner of the robot module can be updated to correct for any waypoints that are not optimal. For example, in the illustrated implementation at FIG. 3, the robot module 102 may have generated waypoints including those shown at ref. 306 which extend beyond a turn 304 in the curb 302, perhaps due to the robot module’s sensors being blocked from accurate sensing of the curb 302’s contour. However, as the robot module 102 approaches the turn 304 in the curb 302, the sensor data gathered by the robot module 102 is processed to reveal that the contour of the curb 302 includes the turn 304 and the sidewall 302b continues along a different direction as shown. Accordingly, based on the updated information from the sensor data, the waypoints are generated or updated to include the waypoints 308 that are configured to maintain the contact or proximity of the brush 112a of the robot module 102 with the sidewall of the curb (and thus the sub-optimal waypoints 306 previously generated are altered or discarded).

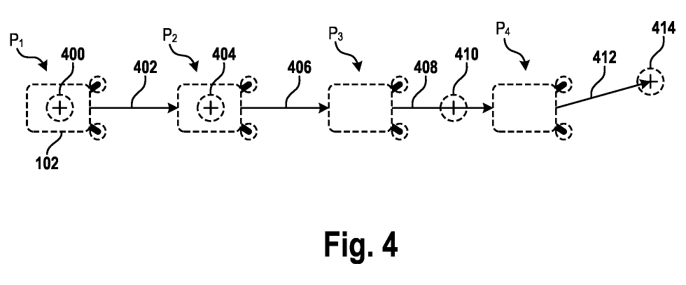

FIG. 4 conceptually illustrates a robot module traversing various waypoints by applying generated velocities, in accordance with implementations of the disclosure.

In some implementations, the robot module 102 includes a local planner that continually generates velocities for the robot module 102 to execute in order to traverse the various waypoints which have been generated by the global planner. The velocities are applied to control the movement of the robot module 102 from moment to moment. As generally understood, each velocity can be represented as a vector quantifying a direction and speed for the robot module to implement.

In some instances, the position of the robot module 102 will coincide with the location of a waypoint. For example, in the illustrated implementation, at an initial time, the robot module 102 is at a position P1, whereby the robot module 102 is positioned at a first waypoint 400. The next waypoint 404 is positioned ahead and accordingly, the robot module 102 generates a velocity 402 that is directed towards the waypoint 404. The robot module 102 traverses the local surface by implementing the velocity 402, so that at a subsequent time, the robot module 102 reaches position P2, wherein the robot module is substantially at the waypoint 404.

It will be appreciated that the position of the robot module may or may not coincide with a waypoint before a subsequent velocity is generated or implemented. For example, from the position P2, the robot module may implement a velocity 406 that is directed towards the next waypoint 410. However, prior to reaching the waypoint 410, the robot module 102 reaches position P3, whereupon a new velocity 408 is implemented. The velocity 408 is configured to direct the robot module 102 from position P3 through the waypoint 410.

After traversing waypoint 410, when the robot module reaches position P4, a subsequent velocity 412 is implemented that directs the robot module towards waypoint 414. As shown in the illustrated implementation, this includes changing the direction of the velocity so as to navigate the robot module towards the waypoint 414.

In some implementations, velocities are generated by the local planner at a constant frequency, such as in the range of about 1 to 100 Hz in some implementations, or in the range of about 5 to 20 Hz in some implementations, or about 10 Hz in some implementations. In some implementations, the frequency at which velocities are generated may vary. For example, in some implementations, the frequency at which velocities are generated is positively correlated to the speed or change in direction of prior velocities. In this manner, as the speed or change in direction of the robot module increases, so the generation of updated velocities increases.

In some implementations, velocities are generated when the robot module 102 reaches a location that is approximately at each waypoint, or at approximately when the robot module is expected to reach the next waypoint based on current execution of the current velocity. It will be appreciated that each velocity is configured to direct the robot module to the next waypoint.

In some implementations, multiple velocities are generated with each cycle of velocity generation. The multiple velocities can be configured to navigate the robot module through a series of the next waypoints, such as through a predefined number of the next waypoints. In some implementations, the multiple velocities can be configured to navigate the robot module through a predefined distance.

It will be appreciated that velocities can be updated based on real-time sensor data that provides feedback to the robot module regarding its location and movement. For example, in some implementations, the location/movement of the robot module is tracked in real-time based on sensor data (e.g. camera, LIDAR, ultrasonic, accelerometers, etc.) and if the robot module is determined to be deviating from its expected movement/location, then new velocities are determined in order to correct the movement of the robot module, such as by redirecting the robot module towards the next waypoint. Also, if the sensor data is processed to reveal the presence of an obstacle (which may itself be moving), then new velocities can be generated to avoid collision with the obstacle, such as by slowing or stopping the robot module’s movement, or redirecting the robot module. In such situations, since the frequency of velocity generation may be higher than the frequency of waypoint generation, then changing the velocities of the robot module will be faster than changing of the waypoints.

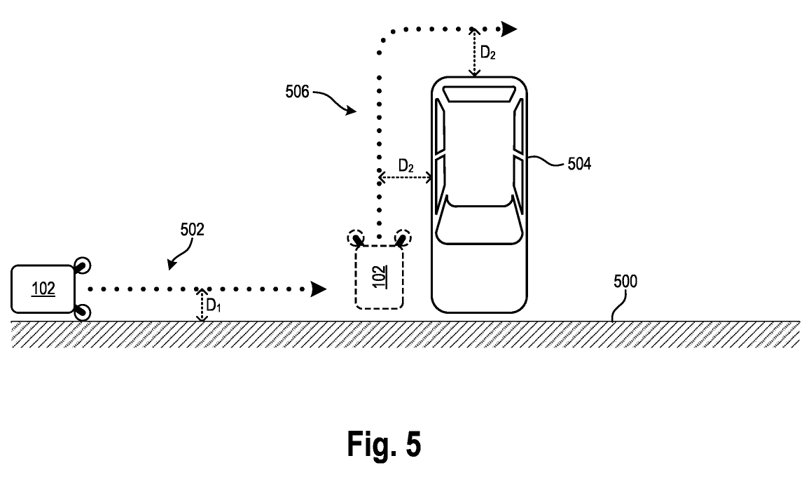

FIG. 5 conceptually illustrates an overhead view of robot module avoiding an obstacle, in accordance with implementations of the disclosure.

In the illustrated implementation, the robot module 102 is shown following a path defined by waypoints 502, so as to adhere closely to the curb 500. As has been discussed, this following of the curb 500 by the robot module 102 can be facilitated by generating the waypoints 502 to maintain a distance D₁ from the curb 500. However, as the robot module 102 traverses the waypoints 502, feedback from its sensors is processed to reveal the presence of an obstacle in the form of a parked car 504 blocking the intended route of the robot module 102 and preventing it from continuing to follow the curb 500. In some implementations, the parked car 504 is recognized using a machine learning model for object recognition, which may be specifically trained to recognize vehicles such as cars, or other types of objects which may tend to be present in the vicinity of the robot module’s operational location. In response to identification of the car 504, and further the car’s stationary status, then new waypoints 506 are generated which define a path around the car 504.

It will be appreciated that while the robot module 102 is sweeping along the curb 500, it operates in a mode configured to maintain contact or close proximity with the curb 500. However, the opposite is true with respect to the car 504, as the robot module 102 should not contact or navigate too close to the car 504. Accordingly, while the waypoints 502 are configured at a predefined distance D1 from the curb 500, the new waypoints 506 are configured at a predefined distance D2 that is greater than D1, so as to maintain a safe operating distance of the robot module 102 from the car 504. In this manner, the robot module 102 is not at risk of contacting the car 504. In some implementations, the distance D2 is configured to maintain a separation distance of the robot module 102 from the car 504 of at least about 0.5 meters.

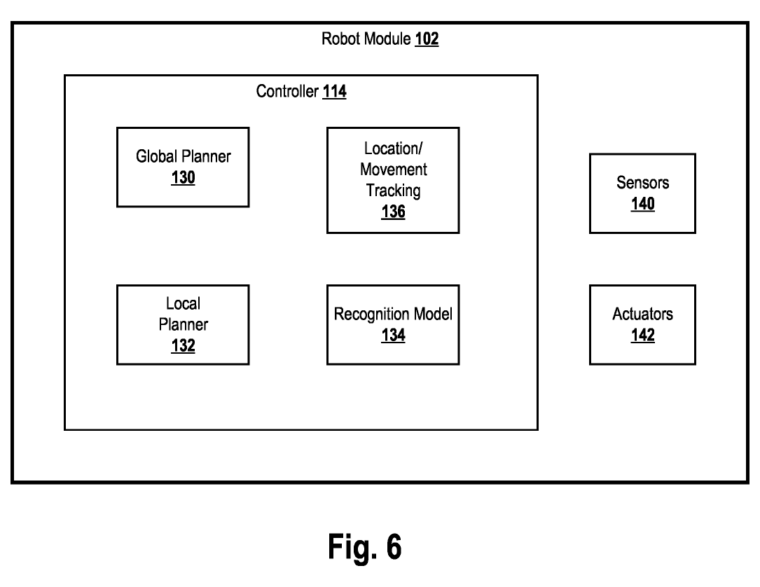

FIG. 6 conceptually illustrates componentry of a robot module, in accordance with implementations of the disclosure.

The robot module includes a controller 114, which can include hardware and software configured to control the operation of the robot module 102, including its movements as described herein. The controller 114 includes a global planner 130 that generates waypoints for the robot module to traverse. The controller 114 further includes a local planner 132 that generates velocities for the robot module to execute.

The robot module includes various sensors 140 that sense characteristics of the local environment in which the robot module is disposed, and/or characteristics of the robot module’s movements or location. In some implementations, sensor data generated by one or more of the sensors 140 is processed by a recognition model 134 to enable recognition of objects in the local environment, such as curbs, roads, parking lot surfaces, vehicles (e.g. car, truck, motorcycle, etc.), persons, trash, etc. In some implementations, the sensor data and/or output of the recognition model 134 is used by a location/movement tracking logic 136 to determine the location and/or movement of the robot module 102. It will be appreciated that the determined location and/or movement of the robot module can be used as feedback to the global planner and the local planner, to enable continued generation of waypoints and velocities in accordance with the implementations of the present disclosure.

The robot module 102 further includes various actuators 142 (e.g. motors, servos, etc.), which are controlled to move the robot module 102 according to the generated velocities by the local planner.

The robot module 102 may include one or more antennas, and can include cameras integrated into the body regions. In some embodiments, the cameras may be integrated to the sides of the outer body of the robot module to enable a 360 degree view. In one configuration, the top portion of the body may open to expose or grant access to electronics associated with the controller 114, electronics for interfacing with batteries of the sweeper module in the robot module 102, and other devices. Some electronics related devices may include processors, microcontrollers, system-on-a-chip processors, application specific integrated circuits (ASICs), memory modules, hard drives, solid state drives, network interface cards, radio communication devices, cellular transceivers, associated operating systems, controller boards, lights, plugs, circuit boards, connection wiring, and associated assemblies.

Other devices, without limitation, may include (without limitation) control systems for cameras, depth cameras, radar, LIDAR, motion sensors, depth sensors, ultrasonic sensors, heat sensors, motion sensors, strain sensors, motor sensors, locking sensors, lifting sensors, docking sensors, and other operational or interfacing sensors. In some embodiments, the wheel configuration can be interchanged, depending on the surface the robot is designed autonomously move about. For example, some wheels may be off-road if the vehicle is used on dirt roads or on farms, or harder surface wheels used in parking lots or smooth surface. In other embodiments, instead of wheels, loop rubber tracks can be used for more off-road operation.

Though in implementations of the disclosure described above, a robot module 102 has been discussed, it will be appreciated that in other implementations, other types of exchangeable modules having different functions can be attached to the robot. For example, a lift mechanism of the robot can be used to attach and retain interchangeable modules/attachments for performing different work functions. The exchangeable modules are physical apparatus structures that may each be configured to perform a unique task, e.g., steam cleaning, vacuuming, grass cutting, polishing, buffing, driveway and/or street cleaning (e.g., sweeping), package grasping and/or moving, etc. In some embodiments, the interchangeable attachments may be configured to perform complementary tasks. For example, for cleaning a floor, the first interchangeable attachment may be configured to vacuum the floor and the second interchangeable attachment may be configured to steam clean the floor.

In some implementations, the interchangeable attachments may be automatically loaded and unloaded from the robot one or more dock assemblies (or docking stations or base stations). The loading and unloading may be performed autonomously, with the robot automatically aligning itself and loading or unloading an interchangeable attachment as needed to accomplish the job assignment that the robot has been programmed to perform.

In some embodiments, the vertical movement of attachments achieved via a lift mechanism of the robot may be utilized as part of performing a task and/or to accommodate interchangeable attachments of different sizes. For example, in the case of a sweeper module the lift mechanism can be utilized to lift the sweeper module to a height required to remove the sweeper module from the dock assembly. The lift mechanism can also be used to lower the sweeper module to the appropriate height for carrying out sweeper operations, such as a height at which the brushes of the sweeper module fully contact the floor.

In some implementations, the robot includes a controller that is configured to control the autonomous functions of the robot. For example, the controller can control the motors which effect movement of the wheels of the robot to move the robot in its operations, such as to control movement of the robot over the sweeper module, and move autonomously along a path to capture debris into the container of the sweeper module. Further, the controller can control the robot’s lift mechanism to lower the lift frame over the sweeper module to connect the alignment pegs with the alignment holes, control the locking mechanism to secure the lift frame to the sweeper module, and control the lift mechanism to raise the lift frame along with the sweeper module toward the interior space of the robot. It will be appreciated that the controller may control these operations in reverse so as to lower the lift frame along with the sweeper module, to seat the sweeper module onto the alignment platform, unlock the sweeper module so as to release the sweeper module, control the lift mechanism to raise the lift frame without the sweeper module, and move the robot off of the dock assembly while leaving the sweeper module at the dock assembly, for example, to allow the sweeper module to charge its battery or be serviced otherwise.

It will be appreciated that in some implementations, the robot includes a battery for powering its motors, lift mechanism, sensory systems, and other electronic systems. The sweeper module can also include a battery for powering the sweeper module, such as powering rotation of its brushes. In some implementations, a battery controller handles sharing of power between the robot’s battery and the sweeper module’s battery. The battery controller can be implemented as part of the robot or the sweeper module, or partially implemented on both the robot and the sweeper. In some implementations, power from the sweeper module’s battery can be shared to the robot to, for example, charge the robot’s battery, power the robot’s motors, lift mechanism, locking mechanism, sensors, communications, etc. Likewise, in some implementations, power from the robot’s battery can be shared to the sweeper module to, for example, charge the sweeper module’s battery, power the sweeper module’s brushes, etc.

In some implementations, the battery of the sweeper module is significantly larger than the battery of the robot, as the sweeper module is retained at the docking station and subject to charging for greater periods of time. Hence, the battery of the sweeper module can be implemented as the primary power source for the sweeper module as well as the robot, and therefore used to power the functions of both units.

In some implementations, when the sweeper module is connected to a docking station, and the robot is connected to the sweeper module, then the battery controller can route power to effects charging of one or both of the sweeper module’s battery and the robot’s battery. It will be appreciated that the battery controller routes power received from the docking station through the sweeper module to the robot, in order to provide power to the robot to charge its battery.

In some implementations, the robot includes a plurality of cameras and a global positioning system (GPS) for controlling movement of the robot by the controller. In some implementations, the robot uses one or more cameras to align with a visible code located at the dock system as described above, and images of the visible code are processed by the controller for guiding the robot to align with the dock system when the robot approaches the dock system for pickup or release of the sweeper module.

Advantageously, robots according to various embodiments disclosed herein may run indefinitely, with the robot constantly swapping batteries and interchangeable attachments as the need arises and as job assignments change. As a result, the robot may function as a home cleaning robot, a commercial cleaning robot, an outdoor robot, an indoor robot, etc. which may autonomously change its abilities without the need of human interaction (e.g., from grass cutting with a grass cutting attachment, to moving bins and crates of an adapter for supporting bins and crates, to cleaning driveways with a vacuum and/or sweeping attachment). An example of the operation of the robot is provided below. It will be appreciated that the sequence below may be performed in the order shown. In addition, omissions of certain actions and/or changes in the order of various actions are also contemplated.

The robot may start off at a charging base station with an interchangeable attachment (e.g., a sweeper module) locked to the main chassis or body of the robot through its retention system. The robot may start off with a power supply (e.g., a removable battery) already in place. The robot heads out of the charging base to perform its assignment (in this case sweeping). When the robot is finished with the assignment (finished sweeping a given area), or when the interchangeable attachment is filled to capacity (e.g., when a sweeper module is filled with debris) the robot will return to the base station or another designated drop area, and detach the interchangeable attachment. The detachment may occur via unlock and pushout of the attachment, or by dropping the attachment under the force of gravity. The robot aligns itself to the interchangeable attachment, or wherever the retention adapters are among the interchangeable attachments, moves towards the interchangeable attachment, centers itself (e.g., using sensors such as a camera) and the retention system locks/unlocks the interchangeable attachment as desired. When the robot approaches the base/charging station, at a certain distance it starts a docking procedure.

The robot maintains a docking distance from the base station to help itself align to the back of the modular box as well as to the retention system before the robot docks. This docking procedure exists in both retaining and detaching the interchangeable attachments at a designated area or a base/charging station. The base station may help guide the robot via sensors and buttons to dock at the base station and aligned with the retention system. In other words, the base station may provide guidance for the robot to return to the station. In addition, the station may include an actuator that shifts the position of the interchangeable attachment to align with the retention system of the robot. The robot may move towards and locate the base station with a variety of sensors, such as live feed cameras, infrared or other proximity sensors, ground sensors, or line detection sensors that are able to follow “tracks” which may be provided on the ground along the path which the robot is to traverse. The tracks may be, e.g., anything from tape that is sensed by the robot, paint sensors disposed or integrated into a surface, or sensors embedded at specific locations in the ground. The use of tracks in one embodiment is optional, since the robot will be able to use its cameras and sensors to navigate and avoid obstacles. The robot may use a variety of sensors such as live feed cameras and/or infrared or other proximity sensors to help locate, and load and unload the interchangeable attachments at a base station or other designated area.

The robot may move to an empty location (e.g., at the base station or at a designated area) and detach its interchangeable attachment. Preferably, this detachment occurs at the location the interchangeable attachment was originally picked up from, e.g., at the space left open when the component was earlier retained by the robot. The robot may then move to another interchangeable attachment for another task. For example, the robot may align itself with a steam cleaning interchangeable attachment located at the base station (e.g., next to or around the vacuum interchangeable attachment), and pick up the steam cleaning interchangeable attachment via the retention system, and then move away from base station to perform the steam cleaning task. In some other embodiments, both the vacuum attachment and the steam cleaning attachment may be loaded onto the robot such that vacuuming and steam cleaning maybe performed without requiring the robot to return to the base station to switch attachments.

The robot can navigate with the help of GPS, in addition to other location devices not positioned on the robot itself or the base station to help with returning to an interchangeable attachment for docking and undocking. These location devices may include Bluetooth beacons or infrared light emitters. In cases where the robot is equipped with a modular, removable power supply, the power supply may be unloaded and a new power supply may be loaded in a procedure similar to the unloading and loading of interchangeable attachments. For example, where the robot has performed various tasks and its attached battery is running low, the robot may: move to a base station containing a charged or charging battery, unload a depleted battery at the base station or designated area, and load another battery.

In cases where the robot is not equipped with a modular, removable power supply, the robot may use a variety of sensors to return to the base station for recharging. The robot may return to the base station to recharge, head off to finish its job, or remain at the base station depending on whether a job assignment has been completed. The robot may be charged while retaining an interchangeable attachment. For example, such charging may be performed via connectors built into the robot that send signals and power to both the interchangeable attachments and the robot’s main computer system. In some embodiments, charging may occur without the robot retaining any interchangeable attachment.

It will be appreciated that the interchangeable attachment may be tracked by the robot using shape/color or design. Such tracking may be utilized to align to the robot for unloading and loading the interchangeable attachment.

It will be appreciated by those skilled in the art that various omissions, additions and modifications can be made to the processes and structures described above without departing from the scope of the invention. For example, it will be appreciated that the robot has been shown without any side panels or other housing around the functional illustrated components. In some embodiments, a housing or shell may be provided around the illustrated components e.g., to protect these functional components from collisions of external objects, weather, or other external phenomena that may damage these functional components.

In addition, the housing may maintain a consistent external appearance and size/shape to the robot, irrespective of the sizes of the interchangeable attachments or the number of retained attachments. This may provide aesthetic benefits and/or allow a consistent interface with other devices external to the robot (e.g., a base station) irrespective of modifications to the internal components or interchangeable attachments. In addition, while various components have been illustrated and discussed as being placed at different locations, it will be appreciated that the relative locations of the various compliments may be varied while still maintaining the functionality disclosed herein.

It is contemplated also that various combinations or sub-combinations of the specific features and aspects of the embodiments may be made and still fall within the scope of the description. Various features and aspects of the disclosed embodiments can be combined with, or substituted for, one another in order.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention could employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

1. A method for controlling autonomous movement by a robot module, comprising:
generating a plurality of waypoints by a global planner;
generating a plurality of velocities by a local planner, said velocities being configured to navigate the robot module through said waypoints;
applying the velocities to control movement of the robot module.

2. The method of claim 1, wherein the waypoints are continually generated at a first frequency, and wherein the velocities are continually generated at a second frequency greater than the first frequency.

3. The method of claim 2, wherein the first frequency is in the range of about 1 to 5 Hertz, and wherein the second frequency is in the range of about 10 to 20 Hertz.

4. The method of claim 1, wherein the waypoints are configured to be about 0.5 to 2 centimeters apart.

5. The method of claim 1, wherein the waypoints are configured so that the movement of the robot module continually positions the robot module in proximity to a curb or wall.

6. The method of claim 5, wherein the positioning of the robot module is further configured to position a sweeper brush of the robot module in contact with, or in proximity to, the curb or wall.

7. The method of claim 1, wherein the robot module is configured to sense a local environment using one or more sensors; and,
wherein generating the waypoints or generating the velocities is responsive to the sensing of the local environment.

8. The method of claim 7, wherein sensing the local environment includes recognizing objects in the local environment by applying a recognition model to sensor data generated by the one or more sensors.

9. The method of claim 7, wherein responsive to detection of an obstacle in the local environment, then the waypoints or velocities are generated so as to avoid contact of the robot module with the obstacle.

10. The method of claim 1, wherein applying the velocities includes activating or controlling one or more actuators of the robot module to control the movement of the robot module according to the velocities.

11. A method for controlling autonomous movement by a robot module, comprising:
sensing a local environment in which the robot module is disposed using one or more sensors of the robot module, wherein sensing the local environment is configured to detect a curb or wall in the local environment;
generating a plurality of waypoints by a global planner, wherein responsive to the detection of the curb or wall, the waypoints are configured to position the robot module at a first predefined distance from the curb or wall;
generating a plurality of velocities by a local planner, said velocities being configured to navigate the robot module through said waypoints;
applying said velocities to control movement of the robot module.

12. The method of claim 11, wherein sensing the local environment is configured to detect an obstacle in the local environment, and wherein responsive to the detection of the obstacle, then the waypoints are configured to position the robot module at a second predefined distance from the obstacle that is greater than the first predefined distance.

13. The method of claim 12,
wherein the first predefined distance is configured to position a sweeper brush of the robot module in contact with the curb or wall, and
wherein the second predefined distance is configured to position the sweeper brush to avoid contact with the obstacle.

14. The method of claim 11, wherein the waypoints are continually generated at a first frequency, and wherein the velocities are continually generated at a second frequency greater than the first frequency.

15. The method of claim 11, wherein sensing the local environment includes recognizing objects in the local environment by applying a recognition model to sensor data generated by the one or more sensors.

16. A robot module configured for autonomous movement, comprising:
a global planner that generates a plurality of waypoints;
a local planner that generates a plurality of velocities, said velocities being configured to navigate the robot module through said waypoints;
one or more actuators that implement the velocities to control movement of the robot module.

17. The robot module of claim 16, wherein the waypoints are continually generated at a first frequency, and wherein the velocities are continually generated at a second frequency greater than the first frequency.

18. The robot module of claim 17, wherein the first frequency is in the range of about 1 to 5 Hertz, and wherein the second frequency is in the range of about 10 to 20 Hertz.

19. The robot module of claim 16, wherein the waypoints are configured so that the movement of the robot module continually positions the robot module in proximity to a curb or wall.

20. The robot module of claim 19, wherein the positioning of the robot module is further configured to position a sweeper brush of the robot module in contact with, or in proximity to, the curb or wall.
